(19) United States
(12) Patent Application Publication
(10) Pub. No.: US 2018/0137456 A1
(43) Pub. Date: May 17, 2018

(54) SYSTEMS AND METHODS FOR AUTOMATICALLY MOVING ITEMS

(71) Applicant: AT&T Intellectual Property I, L.P, Atlanta, GA (US)

(72) Inventors: James Fan, San Ramon, CA (US); Jeffrey Aaron, Atlanta, GA (US); Venson Shaw, Kirkland, WA (US)

(21) Appl. No.: 15/353,445

(22) Filed: Nov. 16, 2016

(51) Int. Cl. G06Q 10/08; G06K 7/10; G06K 17/00

(52) U.S. Cl. CPC G06Q 10/087; G06K 17/0022; G06K 7/10366

(57) ABSTRACT

Embodiments relate to a method, system and storage medium for moving an item from the first location to a second location. The method includes characterizing the item to be moved with a set of item attributes. The method further includes characterizing the first location and the second location with a set of first location attributes and second location attributes. The method further includes specifying goals for the item to move from the first location to a second location. The method also includes accessing an origin template stored in a data store wherein the origin template is associated with the item and the first location and accessing a destination template stored in the data store wherein the destination template is associated with the item and the second location. The method further includes generating a moving plan from the origin template, the destination template and the goals, and executing the moving plan with an agent that moves the item from the first location to the second location.

### TECHNICAL FIELD

The present invention relates to automatic storage and retrieval systems generally, and more particularly to systems and methods for automatically moving items from a first location to a second location.

### BACKGROUND

In today's environment, real estate is getting extremely expensive due to the space availability and limitation. The trend is that many adults have decided to live with their parents or even grandparents. For those who cannot live with their relatives, they may have to share a home or apartment with others due to high rent prices. Similar trend have spread to corporations. Many corporations encourage their employees to telecommute or share their offices with other employees (e.g., Monday and Wednesday: John will work in office but Tuesday and Thursday: Lisa will have the right to use the office). Office hoteling is a method of office management in which workers dynamically schedule their use of workspaces such as desks, cubicles, and offices. Some corporations have redesigned their work space to accommodate office hoteling. Employees will need reserve a work space using a central reservation system when they decide to work at office that day. Employees may need to have equipment or other items moved into the office when they occupy the office and then move the items to storage when they vacate the office.

Consequently, there is a need for extra storage spaces and/or capacity, a way to easily locate items that have been stored and a way to automatically relocate items that have been stored or placed at a first location to a second location. There is a need to automate the retrieval of items from one location and the delivery of the item to a second location.

### SUMMARY

Embodiments relate to methods, systems and storage media for moving an item from a first location to a second location with the use of automation. The method includes characterizing the item to be moved with a set of item attributes. The method further includes characterizing the first location and the second location with a set of first location attributes and second location attributes. The method further includes specifying goals for the item to move from the first location to a second location. The method also includes accessing an origin template stored in a data store wherein the origin template is associated with the item and the first location and accessing a destination template stored in the data store wherein the destination template is associated with the item and the second location. The method further includes generating a moving plan from the origin template, the destination template and the goals, and executing the moving plan with an agent that moves the item from the first location to the second location.

Embodiments also relate to a system for moving an item from a first location to a second location. The system includes a processor, and storage medium coupled to the processor. The system also includes a location characterization subsystem that determines the attributes of the first location and the attributes of the second location and stores the attributes of the first location in the attributes of the second location in the storage medium. The system further includes an item characterization subsystem coupled to the processor that determines the attributes of the item and stores the attributes of the item in the storage medium. The system also includes an item storage and retrieval management module coupled to the processor that executes instructions for specifying goals for the item to move from the first location to a second location; accessing an origin template stored in a data store wherein the origin template is associated with the item and the first location; accessing a destination template stored in the data store wherein the destination template is associated with the item and the second location; generating a moving plan from the origin template, the destination template and the goals; and executing the moving plan with an agent that moves the item from the first location to the second location. The system further includes a moving agent and a user interface.

Embodiments also relate to computer readable media for causing a processor to implement a method including identifying the item to be moved that has been characterized with a set of item attributes. The computer readable media also includes causing a processor to implement a method including identifying the first location wherein the first location has been characterized with a set of first location attributes, and identifying the second location, wherein the second location has been characterized with a set of second location attributes. The method implemented by the processor also includes specifying moving goals by accessing an origin template stored in a data store wherein the origin template is associated with the item attributes and the first location attributes and accessing a destination template stored in the data store wherein the destination template is associated with the item attributes and the second location attributes. The method implemented by the processor further includes developing a moving plan from the origin template and the destination template; and executing the moving plan with an agent that moves the item from the first location to the second location.

### BRIEF DESCRIPTION OF THE DRAWINGS

FIG. 1 is a block diagram of an embodiment of an item storage and retrieval system.

FIG. 2 is a block diagram of an embodiment of an item recognition, tagging and tracking subsystem.

FIG. 3 is a block diagram of a location recognition, tagging and tracking subsystem.

FIG. 4 is a block diagram of an item storage and retrieval management module.

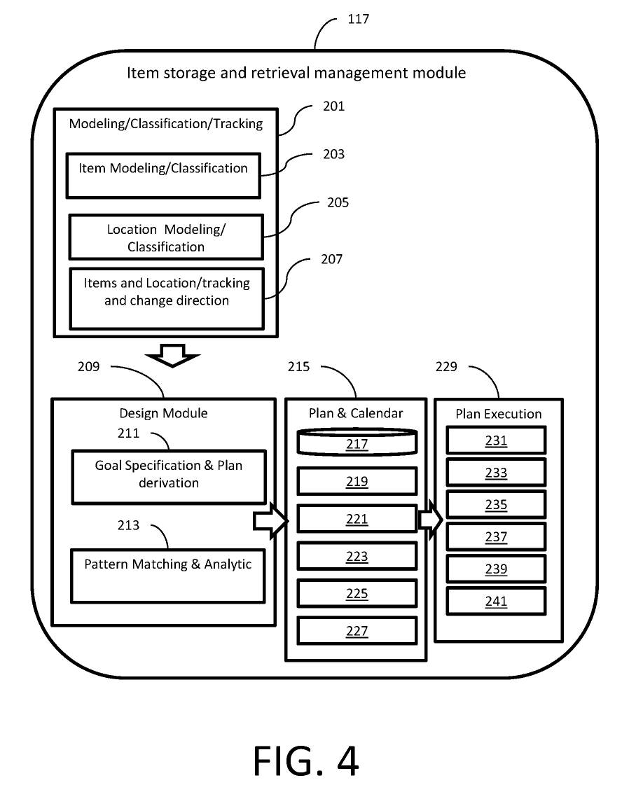

FIG. 5 is a flowchart of an embodiment of a method for moving an item from a first location to a second location.

FIG. 6 is a flowchart of an embodiment of a method for moving an item from a first location to a second location.

### DETAILED DESCRIPTION OF ILLUSTRATIVE EMBODIMENTS

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

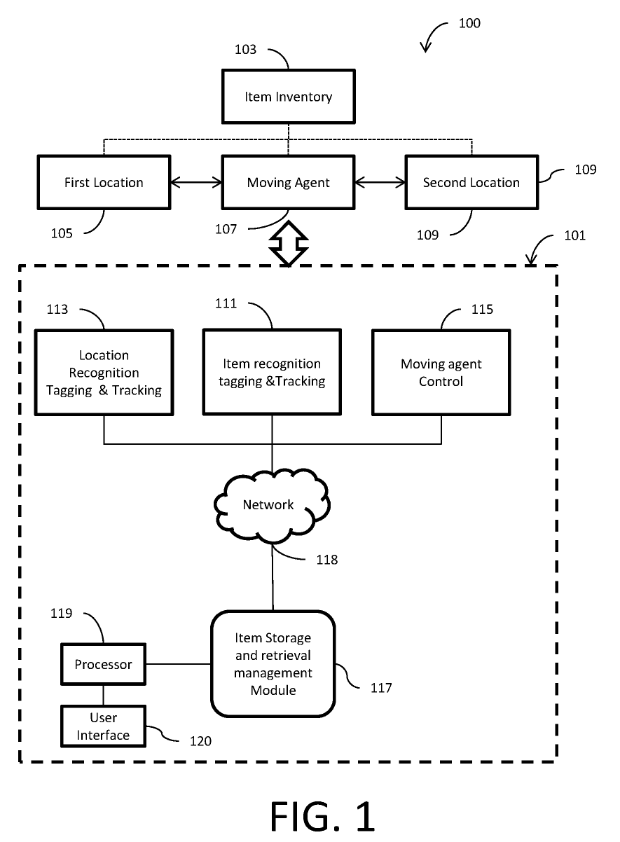

Illustrated in FIG. 1 is an embodiment of the environment in which an item storage and retrieval system 101 may be implemented. The environment 100 includes an item inventory 103 comprising a plurality of items to be stored or placed. These items may include furniture, equipment, files, and personal items among other things. Items may be located at a first location 105, such as a storage location. The items may be moved by a moving agent 107, to a second location 109, such as the location where the item is to be used. The first location 105 may be a warehouse, a storage locker, a garage, a closet, a storage cabinet or any space in which items can be stored. Additionally the first location may be a location where the item is being used temporarily. The moving agent 107 may include a person, a robot, a drone, a moving truck, a forklift or any other instrument capable of moving an item from one location to another. The second location 109 may be an office, a conference room, a room in a house, or any other location where an item may be used or stored.

The item storage and retrieval system 101 includes an item recognition tagging and tracking subsystem 111, a location recognition, tagging and tracking subsystem 113, a moving agent control subsystem 115 and an item storage and retrieval management module 117. The item recognition tagging and tracking subsystem 111, the storage recognition tagging and tracking subsystem 113, the moving agent control subsystem 115, and the item storage and retrieval management module 117 may be connected through a network 118. The item storage and retrieval system 101 may also include a processor 119 and a user interface 120.

The item recognition, tagging and tracking subsystem 111 is responsible for characterizing the items by modeling and classifying the items. Items that need to be stored will go through a modeling step. For example, models of physical items may include attributes such as item name, unique item ID, size, shape, color, materials, weight, uses, usage limitations, movement limitations e.g. unplug video and power before moving and/or wait for recording to finish before unplugging and/or moving, average frequency of need to utilize, dependencies on other items, etc. This modeling step may be fully automated may be accomplished with an intelligent video 3D scanning and recognition process. The item recognition, tagging and tracking subsystem 111 will generate metadata associated with the item.

Models provide simplified (yet knowledge rich) representations of real-life items and storage spaces, so that execution plans can reference these, and so that the process of determining execution plans can operate properly, specifically, and precisely. Relationships and associations are inputs into models. Models are used in different ways in the item storage and retrieval system 101. First of all, a model is used in inventory stage of the item storage and retrieval system 101. Data and/or information models are used to help identify inventory items (which are objects such as tables, chairs, sofas, etc.) and storage spaces and/or dimension and/or weight such as public storage spaces, local or remote warehouses, community shared spaces, and/or user specified storage spaces (e.g., such garage or sheds in backyard, etc.). These data models will be provided by the service provider. However, users need to trigger the inventory action (e.g., to trigger a drone dispatched to inventory items in a room).

Models are used in plan derivation and plan execution stages. One example here is to use a Business Process Execution Language (BPEL)-like process model. In this case, after the templates described in (b) are selected and modified, a moving order is generated. The order will be parsed and analyzed by a front-end processor of the BPEL-like engine to allow step by step process to be mapped out. The mapped out BPEL-like model will be executed for the purpose of moving plan execution at the due time. At the due time, BPEL-like engine will execute the plan model.

The location recognition, tagging and tracking subsystem 113 is responsible for characterizing the first location 105 and the second location 109 by modeling and classifying the first location 105 and the second location 109. Storage locations and locations where items are to be used will go through a modeling step. For example models of a storage location may include attributes such as the type of storage location (self-storage unit, garage, closet, etc.), the dimensions of the storage location, the geographic coordinates of the storage location, location RFID device identification, whether the space is rented, whether the space is readily accessible among others.

The moving agent control subsystem 115 provides directions and controls the human robotic agents that are trained to execute requests according to a plan to either bring the items to storage or retrieve the items from storage in an intelligent way.

The item storage and retrieval management module 117, as described further below, provides the modeling classification and tracking functionality as well as the moving plan design, scheduling and plan execution.

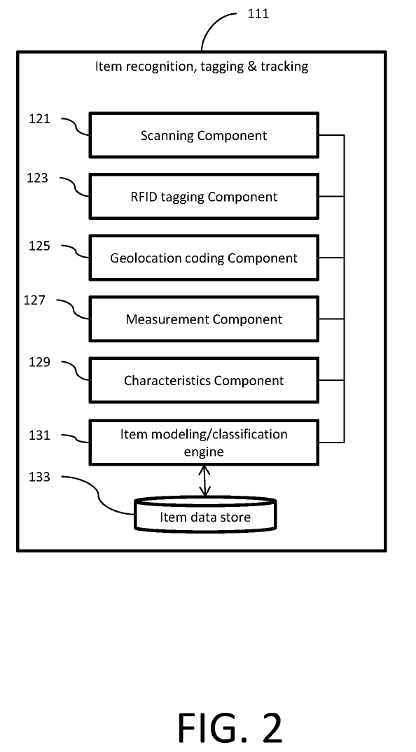

As shown in FIG. 2, the item recognition, tagging and tracking subsystem 111 may include a scanning component 121 for scanning the items, a tagging component 123 for tagging the items with an item RFID device, a geolocation component 125 for geolocation coding of the items, a measurement component 127 for measuring and specifying the measurements of the items, and a characteristics component 129 for further identifying other characteristics of the items. Scanning of the item may be accomplished by using a 3-D scanner manually or a 3-D video camera equipped drone or robot. Item characteristics may include whether it is rentable, and attributes such as item name, unique item ID, size, shape, color, materials, weight, uses, usage limitations, movement limitations (e.g. unplug video on power before moving in or wait for recording to finish before unplugging and/or moving) average frequency of need to utilize dependencies and other characteristics. Information associated with the modeling and classifying of the items is processed by an item modeling classification engine 131 and is stored in an item data store 133. The modeling and classification of the items may be fully automated and may be performed thoroughly and intelligent video 3-D scanning and recognition process. In some embodiments there may be manual intervention to enhance the model real time.

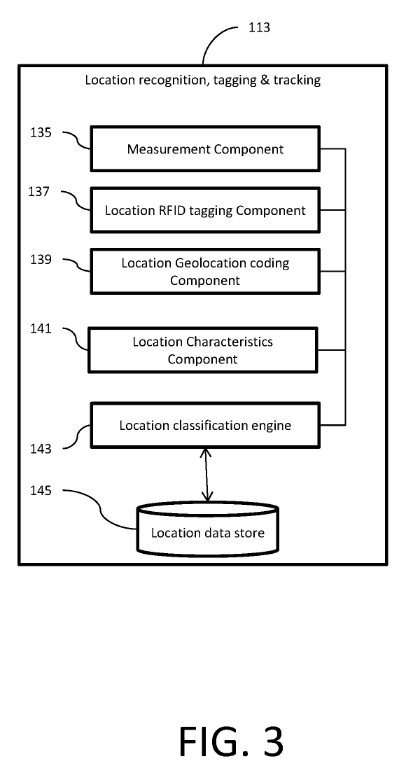

The location recognition, tagging and tracking subsystem 113 is responsible for measuring use and storage locations, tagging the use and storage locations (first and second locations) with an RFID device and coding the geolocation of the use and storage locations. All physical storage spaces and/or resources and/or capacities will be modeled based on their size, location, vacancy status, distance, agent accessibility and user preferences. As shown in FIG. 3 the location recognition tagging and tracking subsystem 113 may include a measurement component 135, to measure the storage space or the use space; a location RFID tagging component 137 to tag the storage space and the use space with an RFID; a location geolocation coding component 139 for identifying the location of the storage space and the use space; and a characteristics component 141 for identifying additional location characteristics of the storage space or the use space. The storage recognition tagging and tracking subsystem 113 may also include a location classification engine 143 for processing data from the measurement component 135, the location RFID tagging component 137, the location geolocation coding component 139 and the characteristics component 141. The processed data may be stored in a location data store 145.

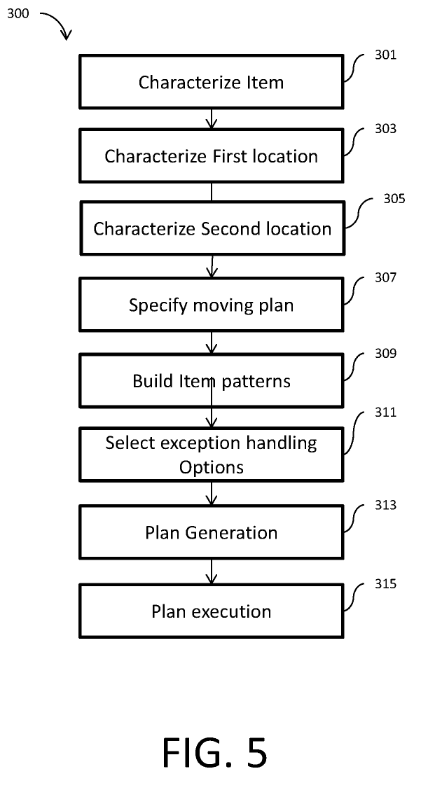

The item storage and retrieval management module 117 manages the activities of the item storage and retrieval system 101. Illustrated in FIG. 5 is the storage and retrieval management module 117. The storage and retrieval management module 117 includes an item modeling, classification and tracking component 203 which may include an item modeling, classification and tracking component 203, a location modeling and classification component 205 and an items and location tracking and change direction component 207. The item modeling, classification and tracking component 203 processes the characteristics of the items characterized by the item recognition tagging and tracking subsystem 111. The location modeling and classification component 205 processes the characteristics of the first location and second location characterized by the location recognition tagging and tracking subsystem 113.

The modeling classification and tracking module 201 includes an item modeling and classification component 203, a location modeling and classification component 205 and an item and location tracking and change direction component 207. The item and location tracking and change direction component 207 keeps track of the changes in location of the items as they are moved and generates metadata associated with the changes.

The item modeling, classification and tracking component 203 models the plurality of items with needed attributes that can be tracked and searched easily. The data for modeling the items is developed by the item recognition tagging and tracking subsystem 111. The models of physical items include attributes such as item name, unique item ID, item dimensions, shape, color, materials, weight, uses, usage limitations, item geolocation data, movement limitations (e.g. unplug video and power before moving and/or wait for recording to finish before unplugging and/or moving), average frequency of need to utilize, dependencies on other items, etc. For example, the characterization of items may include the attributes shown in Table 1. The attributes listed in Table 1 are not exhaustive and additional attributes that may be useful in characterizing an item to facilitate movement from a first location to a second location may be included.

TABLE 1

| | Item RFID | | | Readily |
|---|---|---|---|---|
| Item name | Identification | Dimensions | Geo-ordinates | accessible |
| Dining | D12345 | 12′ by 4′ by 3.5′ | 223, 154, 000 | No |
| table | | | | |
| Dining | D12346 | 2′ by 2′ by 2.5′ | 223, 166, 000 | No |
| chair 1 | | | | |
| Table | D18101 | 1′ by 1′ by 6′ | 224, 188, 000 | Yes |
| lamp | | | | |
| Painting 1 | D19101 | 3′ by 3′ by 4′ | 226, 199, 050 | No |

The location modeling and classification component 205 models the physical locations, resources and capacities based on their size (location dimensions), location, location geolocation data, RFID identification, vacancy status, distance, agent accessibility and user preferences. For example the characterization of locations may include the attributes listed in Table 2. The attributes listed in Table 2 are not exhaustive and may include additional attributes that may be useful in characterizing a location to facilitate movement from a first location to a second location.

TABLE 2

| | Location | | | |
|---|---|---|---|---|
| Location | RFID | | | Readily |
| Name | Identification | Dimensions | Geo-Ordinates | Accessible |
| Garage | S12345 | 15′ by 15′ by 9′ | 523, 154, 000 | Yes |
| Park | S12346 | 100′ by 30′ by | 577, 335, 000 | No |
| outdoors | | unlimited | | |
| Community | S18101 | 50′ by 30′ by 9′ | 600, 188, 000 | Yes |
| room | | | | |
| Rental 777 | S19101 | 25′ by 25′ by 7′ | 1226, 245, 030 | No |

The item and location tracking and change direction component 207 keeps track of the changes in location of the item when the item is moved and generates metadata associated with the change in location.

The design module 209 includes a goal specification and plan derivation component 211 that processes location management goals & high-level intentions of the user. Location management goals & high-level intentions are created based on various inputs, sometimes manually, but also sometimes automatically, using generic templates which are customized for users and situations. Location management goals & high-level intentions may also be obtained from other users (e.g., crowd sourced). Users may define goals using service provider provided templates. These templates can be defined and/or arranged in various ways. For example, in order to move items from living room to dining room, at least two templates will be leveraged. A living room template will allow users to select items that need to be moved out. A dining room template will be used for users to make selected items to be moved into the dining room. Attributes in the templates are closely tied to data models defined above. In an embodiment whatever is defined in the data models may show up in the “FROM” template. FROM template may have more items than what the users specified, but these extra items will be dimmed. “From” and “To” can include aspects of before and after, from one location to another, etc. Execution plans may sometimes include multiple “From's” and “To's” depending on what is being done. These may be combined in various ways as needed, e.g. additive, using priorities, rule-based combining, etc. An example of the template may include a moving out to storage template that has location and item specifications such as Kitchen Small, Kitchen Medium, Kitchen Large, Living Small, Living Medium, Living Large. Another example may include a rearrangement template that has location and item specifications such as From Living-Sofa, Piano, Table; To Family-Sofa, Piano; to Yard-Table. Yet another example may include a remodeling template that has location and item specifications such as From Living-Sofa, Piano, Table; To Yard-Sofa, Piano, Table; Back to Living-Sofa, Piano, Table. Yet another example of a template may include a daily template that has location and item specifications such as from office XX—desk-keyboard, mouse, folders; to central storage—keyboard, mouse, folders; back to office YY—desk-keyboard, mouse, folders. Graphic interfaces to indicate moving desires may be used, e.g. combined with camera input to provide an overlay of items that could be moved, and also with list of items already in storage (not visible in a room at that time). Analysis of calendars along with the preferences of potentially affected user will automatically generate potential goals and/or intentions, which can be presented to the user for validation. Each goal and/or intention will eventually cause an execution plan to be created (see below). Examples of automatically generated goals and/or intentions might include:
1. Make necessary work items available at home each Wednesday, due to calendar entries indicating Work-At-Home.
2. Move relevant items outside onto the porch on days when the weather is nice, due to preference entries indicating desire to be outside as much as possible in certain seasons such as Spring and Fall.
3. Rearrange furniture and decorative items due to Holiday schedules and preference such as Christmas.
4. Rearrange items due to scheduled children's activities.
5. Rearrange items due to new hobbies and related activities at certain times of day, such as practicing a musical instrument.
6. Automatically lend items to scheduled community activities, such as deck chairs & tables & plates etc.
7. Automatically set up videoconferencing equipment such as cameras to accommodate schedules.
8. Change furniture due to seasons.
9. Change outdoor furniture due to weather, such as umbrellas & elective fans.
10. Quickly provide additional furniture for unexpected guests.
11. Automatically move items from common storage to a particular deck each day as employees come into a shared work area where desks are signed for prescheduled daily, and then back to storage at the end of the day.

The design module 209 also includes a pattern matching and analytic component 213 that builds and leverages patterns, relationships, and associations for items that need to be managed or stored away. The pattern matching and analytic component 213 may build associations between the items, and between the first location geolocation data, the second location geolocation data and the item geolocation data. Items may be associated together as a group. For example, if a coffee cup needs to be stored away, its associated little plate may have to be stored together so that as a pair can be retrieved at the same time. Another example of a pattern is a table and four chairs may be grouped so that they can be moved in and out together. In another example, the pattern may be that a dining room set will always be moved in or out between the dedicated storage in the dining room. In yet another example the pattern may be that the user always goes to a pre-booked office hotel area in an office at 8:00 am. In that case a rule will cause the setup of the office environment at 7:45 am before the user arrives at the office. The association function includes the building of associations by the design and creation of patterns (of items in a room, items in a group, etc.), recognition of designed patterns, and execution recognized designed pattern. Patterns can range from one item alone to many items considered as a whole; large patterns can include smaller patterns as components, and all patterns can be implemented as information models. Patterns may include attributes just like models, and in a sense are larger more complex models relative to models of individual items. Patterns may include usage limitations, movement limitations, etc. Modeling and associations may also include ownership, e.g. an umbrella or TV or iPad may be owned by a family or an individual, whereas a toy or bicycle is typically owned by a specific individual, and the actual ownership should be specified in each cases where it is important. Also, whether or not an item can be borrowed may be indicated, and whether a fee is charged for that, and the amount and terms.

Patterns will be derived from observations, and/or may sometimes be entered manually or via import (e.g., being obtained from other users in various ways). Observations are derived from analytics. The item storage and retrieval system 101 will collect user behavioral data by tracking the user daily activities and/or preference(s), user's calendar items, individual or group item movement histories as well as user initiated movement request history information. The collected information will use pattern matching mechanism to derive intelligence. Pattern intelligences are applied to two areas. First, the intelligence will be used to shuffle how the items should be inventoried. (One example is when the item storage and retrieval system 101 detects that the keyboard of the computer is being inventoried and retrieved every few hours, it will move the keyboard to a closer and readily accessible storage space.) Second, the pattern will be used to drive non-user initiated moving plans. (One example is when the system detects a user goes to work at 8:00 am and comes back to home at 3:00 pm and continue to work on company computer for another 2-3 hours, a daily moving plan will be established automatically by the system which is to create a nice work area with all accessories set up (moving things around) before 3:00 pm so that the user can continue to work seamlessly.). However Patterns may need to be dynamically adjusted based on real time contextual data received. This means that a pattern can be violated and/or interrupted due to unforeseen contextual data and/or event received. For example, in the prior example, if the system detects that the user requests to set up a barbecue arrangement in the backyard at 2:10 pm, this implies the pattern is no longer true and thus the pattern generated daily moving plan will be suspended and/or overwritten.

Contextual information is critical to (i) enrich the moving experience and (ii) help to deal with real time detected exception situations. This implies that user and object contextual information will be gathered by the item storage and retrieval system 101. For example, if it is noticed that the user has not reach home by 4:00 pm and contextual information showed that the user may be heading towards an opposite direction, the contextual information will issue a pattern violation request notification to trigger all accessories to be moved back to the original places—implied the daily plan is reverted.

The plan and calendar module 215 may include a plan repository 217, a calendar component 219, a dependence analytics and management component 221, an exception handling pre-planning component 223, a preplanned execution sequence command generation component 225, and a resource booking component 227.

The calendar component 219 can allow users or system to schedule moving or rearrangement activities. All calendar items will be executed in scheduled future time. This submodule is tightly integrated with functions in the Design Module so that each designed project or activity can get an associated calendar item created, stored and linked. The calendar item can then be used to determine when a designed plan needs to be executed in 229.

The dependence analytics and management component 221 can identify and track dependencies related to calendar, plan and tasks within a plan, e.g. for a scheduled item move. This function can be used to identify potential conflicts and can perform validation functions prior to the execution of the plan.

The exception handling pre-planning component 223 allows the building of a cushion to deal with unexpected situations. Exceptions are based on contexts that may happen during the plan execution time. Contexts which include and model non-process situations, e.g. things which are happening at the same time like visitors being present, temporary limitations on certain things such as heavy rain, environment hazards, accident, abrupt weather change, etc. Contexts can be handled in a number of ways, e.g. as exception rules that can be selected and assigned to models or patterns, and/or as rules that are triggered when specific detections occur (e.g., a small child has wandered into a room where the furniture needs to be moved triggers notification of parents and waiting until the room is clear, before moving can be resumed). Contexts and handling of same are likely to be numerous and need to cover most if not all practical occurrences which may need to be considered in the operation of the item storage and retrieval system 101, for reasons of safety, efficiency, and even to allow basic operation without errors, blocking or accident. Where possible, contexts are avoided by scheduling moving of items at night when people are asleep, or at other times when contexts are minimal or do not occur. For example, a homeowner may wish to remodel the floor in the dining room. One day prior to the floor remodeling date the system may be programmed to move the dining room set to the backyard. However, if it's raining the exception handling options may direct the construction of a tent before the moving activity begins.

The preplanned execution sequence command generation component 225 develops a moving plan to be executed by the moving agents. Based on inputs from the item modeling, classification and tracking component 203, the design module 209, the calendar component 219, the dependence analytics and management component 221, and the exception handling pre-planning component 223, the preplanned execution sequence command generation component 225 maps out an execution plan. Planning (e.g., to create or assemble Sequences) and executed to accomplish movement, arrangement and/or storage of items. Contexts are considered in order to select variations of sequences and/or modify resulting sequences. Sequences are used to control the process, but the sequences themselves can be designed to include a hierarchy so that portions of a sequence can be filled in or customized at the last minute to specify a targeted use of a general re-usable sequence as needed, e.g. move the lamp to the bedroom rather than to the living room. Each level of sequences may be designed in advance, but applied at the last minute. The plan may also include detailed maps with geocoding for each item's destination.

The resource booking component 227 performs resource management as needed. For example, it can decide if a group of human staff or a group of robots (or a combination of the two) need to be dispatched to perform the plan execution, and also how many and of what types and/or skills. It may also accomplish sequencing of resources, e.g. from one move to the next, if applicable. This allows various types of resource reservation to be done ahead of time to avoid lack of resources needed during the execution time.

The plan execution module 229 may include a preplanned task information validation component 231, a real time adjustment component 233, a real time dispatch and control component 235, a client communication and notification component 237, a real time logging component 239 and a monitoring and auditing component 241.

The preplanned task information validation component 231, prior to execution time (e.g., scheduled time), will examine the plan in great detail to determine if there are potential issues and if there is a need to mitigate those possible issues during execution time. Identified issues could cause the plan to be adjusted a bit, in order for things to proceed smoothly. Since this is done a few minutes or hours ahead of time, the mitigation should reduce incidences of conflict that may potentially occur during the execution time. For example, a particular plan execution might last longer than expected due to earthquakes or traffic congestion, which caused resources to tighten up, and thus may impact subsequent plan executions.

The real time adjustment component 233 provides the ability to adjust the plan during the actual execution time. For example, when moving a table from a living room to a garage, it may notice that a car is parked them unexpectedly. A real time adjustment will be needed, and must be identified. An appropriate adjustment is selected (e.g., using predefined option lists, model analysis, etc.) and ordered.

The real time dispatch and control component 235 performs the “dispatch” function in real time. It can work as needed with the Real-Time Adjustment Component, hand in hand, to dynamically adjust required resources and order or command the sequence of action needed to accomplish moves from one location to another, for example. This component handles the “dispatch” function for both human and robot or nonhuman resources.

The client communication and notification component 237 handles all necessary notifications and communications to or from the user. For example, it may call the user 2 hours ahead of a planned execution to make sure the user has not changed his/her mind. It may also send reminders. In addition, during a plan execution time, this module will continue to offer status information to the user as needed or preferred. For example, as directed or previous set in user preferences, it may provide streaming video, allowing the user to see what is going on.

The real time logging component 239 performs continuous logging functions so that every significant move is being logged and/or recorded. This log can then be used as both evidence and data, e.g. for use by future analytics to improve execution efficiencies.

The monitoring and auditing component 241 may be thought of as a kind of “insurance” function. This external module can be utilized to keep an eye on the progress of a planned execution in real time. It receives status reports from all human and robot agents. It also receives real time feedback from storage areas and other instrumented entities, which can be used in various ways. For instance, if a “high alert” is detected, it might notify the Real Time Adjustment Component of the possible need for a mitigation plan. Worst case, if an automatic mitigation cannot be accomplished, the Real Time Adjustment Component could then notify the service provider's “trouble management” staff so that they could look into the matter.

The plan execution module 229 executes the plan through the use of agents. The plan will be executed based on schedule and adjusted automatically per calendar conflict by human agent, robot, drone or combination of all. Additional plans may be created and executed automatically without involvement of the users based on patterns and deep learning by human or robot agents. Each storage management moving plan may be triggered on-demand or on schedule and may be adjusted manually or based on context based exception handling procedures. Multiple level of execution orchestration may be needed. For example, a typical moving plan execution may include two level of orchestration. A High-level Orchestration covers overall for movements in, to or from the home) and a Low-level Orchestration includes agent level in terms of planning transport and last-meter positioning. In addition, Monitoring, and Optimization Learning capabilities are also included. Specific orchestration aspects can be overridden by the user, e.g. put the lamp on the right instead of the left. An agent or a group of agents can be robot, drone, human, autonomic vehicle or any combination of them.

A service provider (e.g., telecommunication carrier) may make use of the item storage and retrieval system 101 for revenue generating service delivery leverage the existing infrastructure. In summary, the item storage and retrieval system 101 based on modeling for inventorying, plan derivation and plan execution. This inventory uses pattern recognition to drive non-user generated moving plans. The inventory uses contextual information to make real time plan adjustment as well as to perform exception handling activities. Modules (connected by a network where appropriate, and/or some co-located in some implementations): Home Status Detection & Audio/Video Triggering Module (continuously keeps track of all items in the home and their locations, e.g. via RFID, video imaging sensors, etc. even when someone brings something in from outside, e.g. a new lamp that has been purchased from a store, as well as significant or relevant changes in the home, e.g. unexpected visitors) User Input Module (user adds goals, preferences, policies and/or rules, etc.) Design Module (creates and/or imports models, patterns, sequences, contexts, etc.) Calendaring/Calendar Interface Module (helps provide automatic inputs for triggering) Dependency Analysis Module (moderates and customizes inputs to triggering) Learning/Training Module (learn from historical usage and errors regarding specific models, pattern, sequences) User Needs Module (takes inputs from above and/or directly from the user and generates triggers) Planner Module (generates sequences while taking into contexts) Drone/robot Command Generation Module (executes sequences via communication and delegation to drones) Drone/robot Tracking/Movement Logging and Monitoring Module (ensures proper operation and results) Error/Exception Handler Module (can feed back to Learning/Training Module).

Illustrated in FIG. 5 is a method for the automatic management of physical items 300.

In step 301 items are characterized by identifying, modeling and tagging each item with an RFID tag. As described above, each item can be identified using a 3-D scanner manually or a 3-D video camera equipped drone or robot. Scanned items will be RFID tagged, geolocation coded, measured and associated with certain characteristics (e.g. rentable, etc.). Each item is then classified and inventoried. Each item that needs to be stored will be modeled. The modeling step is fully automated and may be accomplished via an intelligent video 3D scanning and recognition process. In some embodiments there may be manual intervention to enhance the model real time.

In step 303 the first location is inventoried using a computer cloud-like model and characterized by identifying, classifying, virtualizing and tracking the volume availability of the first location. The first location space is measured, RFID tagged and geolocation coded. The characteristics of the first location are then specified (e.g. free, for rent, cost, 24-hour accessible, etc.). All physical storage spaces, resources and/or capacities will be modeled based on their size, location, vacancy status, distance, agent accessibility and user preferences.

In step 305 the second location is inventoried using a computer cloud-like model and characterized by identifying, classifying, virtualizing and tracking the volume availability of the second location. The second location space is measured, RFID tagged, and geolocation coded. The characteristics of the second location are then specified (e.g. free, for rent, cost, 24-hour accessible, etc.).

In step 307 the moving plan is specified. This includes goal specification for items moving into or out of the target location (moving plan creation). Here the user specifies moving goals which causes the system to auto select appropriate templates to craft a plan. The user can overwrite the system selected templates or even create new templates if needed. Finalized templates and/or plans may be validated (e.g. against calendar, etc.). Storage management goals & high-level intentions are created based on various inputs, sometimes manually, but also sometimes automatically, using generic templates which are customized for users and situations but may also be obtained from other users (e.g., crowd sourced). Graphic interfaces to indicate moving desires will be used, e.g. combined with camera input to provide an overlay of items that could be moved, and also with list of items already in storage (not visible in a room at that time). Analysis of calendars along with the preferences of potentially affected user will automatically generate potential goals and/or intentions, which can be presented to the user for validation. Each goal and/or intention will eventually cause an execution plan to be created (see below).

Examples of automatically generated goals and/or intentions might include:
1. Make necessary work items available at home each Wednesday, due to calendar entries indicating Work-At-Home.
2. Move relevant items outside onto the porch on days when the weather is nice, due to preference entries indicating desire to be outside as much as possible in certain seasons such as Spring and Fall.
3. Rearrange furniture and decorative items due to Holiday schedules and preference such as Christmas.
4. Rearrange items due to scheduled children's activities.
5. Rearrange items due to new hobbies and related activities at certain times of day, such as practicing a musical instrument.
6. Automatically lend items to scheduled community activities, such as deck chairs & tables & plates etc.
7. Automatically set up videoconferencing equipment such as cameras to accommodate schedules.
8. Change furniture due to seasons.
9. Change outdoor furniture due to weather, such as umbrellas & elective fans.
10. Quickly provide additional furniture for unexpected guests.
11. Automatically moving items from common storage to a particular deck each day as employees come into a shared work area where desks are signed for prescheduled daily and then back to storage at the end of the day.

In step 309 item patterns are built. For example, use patterns may be used to associate items that may need to be stored away as a group. The pattern building activity involves building and leveraging patterns, relationships and associations for managed and/or stored away items. Patterns include collections of related associations, relationships, etc. which are observed. For instance, the item storage and retrieval system 101 may determine that a user works at home most Wednesdays. Patterns may be included in models as special information, e.g. as triggers, additional description, notes, etc. The system starts to build associations and relationships among items and between items in geolocation. The system starts to look for possible patterns to enhance the experience (e.g. if the user has a routine pattern of leaving office at 4:00 pm, the robot may come to pick up the keyboard at 3:50 pm instead of prep prescheduled 4:20 pm). This step introduces association concepts. Items may need to be associated together as a group, or this may be useful. This step includes but not limited to the followings: Design and creation of Patterns (of items in a room, items in a group, etc.), Recognition of designed patterns, Execute recognized designed pattern.

In step 311 an exception handling options may be selected. The user may select exception handling options for each goal specification and/or plan. The default is “system decision” which implies that the system will make real-time exception handling decisions. The user may request that the system send alerts before executing the exception decision for on demand change. This step allows the building of a cushion to deal with unexpected situations. Exceptions are based on contexts that may happen during the plan execution time. Contexts which include and model non-process situations, e.g. things which are happening at the same time like visitors being present, temporary limitations on certain things such as heavy rain, environment hazards, accident, abrupt weather change, etc. Where possible, contexts are avoided by scheduling moving of items at night when people are asleep, or at other times when contexts are minimal or are unlikely to occur.

In step 313 the execution plan with a schedule is generated from the templates. Planning (e.g., to create and/or assemble Sequences) and executed to accomplish movement, arrangement and/or storage of items. Contexts are considered in order to select variations of sequences and/or modify resulting sequences. Sequences are used to control the process, but the sequences themselves can be designed to include a hierarchy so that portions of a sequence can be filled in or customized at the last minute to specify a targeted use of a general re-usable sequence as needed, e.g. move the lamp to the bedroom rather than to the living room. Each level of sequences can be designed in advance, but applied at the last minute. The plan may also include detailed maps with geocoding for each item's destination.

In step 315 the execution plan is executed by agents (e.g. person, drone, robot, autonomous vehicle, etc.). When the user finishes up a goal specification and exception handling steps the plan will be executed based on schedule and adjusted automatically per calendar conflict by human agent, robot, drone or combination of all. Additional plan may be created and executed automatically without involvement of the users based on patterns and deep learning by human or robot agents. Each storage management or moving plan can be triggered on-demand or on schedule and can be adjusted manually or based on context based exception handling procedures.

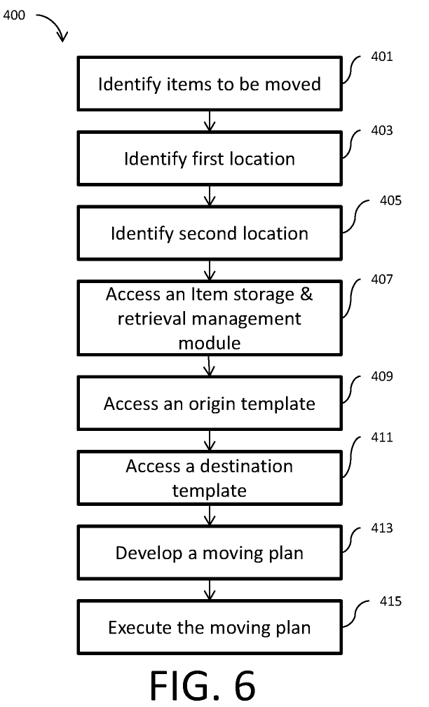

Illustrated in FIG. 6 is a method for moving an item from a first location to a second location.

In step 401 the items to be moved which have been characterized are identified.

In step 403 the first location which has been characterized is identified. The first location may be a storage location or a temporary use location.

In step 405 the second location which has been characterized is identified. The second location may be the location where the item is to be used or stored.

In step 407 and item storage and retrieval management module 117 is accessed and provided with the information associated with the item to be moved, the first location and the second location.

In step 409 the item storage and retrieval management module 117 accesses an origin template associated with the item to be moved and the first location.

In step 411 the item storage and retrieval management module 117 accesses a destination template associated with the item to be moved and the second location.

In step 413 the item storage and retrieval management module 117 develops a moving plan.

In step 415 moving agent executes the moving plan.

The embodiments of the methods and systems disclosed herein provide the following functionality:
(a) application of Cloud and Virtualization concept to physical items and their storage needs.
(b) enablement of a physical resource sharing model to home owners and enterprise business offices.
(c) Just in time items availability via robotic technology.
(d) Automatic inventory, classification and management systems.
(e) Automatic find and/or retrieve physical items for particular user according to the “Right to Use” during a specific “time period”

The following list of features are provided by the systems and methods of the various embodiments:
a. Possessions are automatically added to inventory, tracked (e.g. via RFID, video surveillance, periodic discovery via drones and/or robots, etc.), organized (virtually), and retrievable.
b. Storage can be distributed to local or remote location and optimized for maximum efficiency, since the organization itself is virtual rather than physical.
c. The user can easily view and/or determine what is available, and request items with no trouble (e.g., without having to remember where it is, how it was organized, actually retrieve it physically, etc.)
d. If something is moved (by people incl. guest or residents or servant such as butlers, maids, etc., forces of nature such as wind etc., by automation, drones, etc.), the system will track the new location such that organization and knowledge of items is always maintained and continuously updated. Further, coordination between all the processes and actors (e.g., various types of drones and automation) ensure that the system's integrity and availability is always maintained.
e. All actors and automation communicate continuously so that movements can be optimized. Actors may be drones, robots, other types of devices or machinery controlled by the system, human servants communicating with the system or directed by the system via headsets, etc.).
f. The system can utilize schedules and calendars to implement movements during convenient or preferred or “best” times automatically (e.g., when residents are asleep) using the system's intelligence, without the user needed to direct or manage these actions manually.
g. The system can automatically determine when particular items are needed and move them into place automatically, and then remove them after they are no longer needed. Various intelligent apps can be added over time to increase the system's intelligence and capabilities in this regard.
h. The user interacts with the system via several methods, e.g. a smartphone app, a web graphical user interface (GUI), verbal commands in the home, an electronic calendar, etc.
i. The system monitors all the user's inputs and comments in order to learn the user's schedule, calendar habits, preferences, and exceptions to these. The system constructs a customized rule-base (of policies and priorities, at least conceptually) for each user, and applies this to decisions in order to obtain the best outcomes. This customized rule-base is utilized in addition to foundational and/or default rules bases, each of which may be used to capture “common sense” intelligence or other helpful intelligence not specific to any particular user. Optionally, users could be categorized (either automatically or via self-description) so that specific rule-bases for those categories of users could be added. All rule bases are additive, with algorithms included to combine results of using multiple rules in particular situations.
j. A user may override, supersede, or interrupt the system at any point. For instance, if the system has moved something into place after determining the user will need it because of calendar entry information, but the user realized the system has misinterpreted the information (and the item is not needed or desired), the user can command the reversal of the move so everything return to where it was in real-time, etc.
k. The system also keeps a log for tracking the activity and history of physical item movement so that user preference and user dis-preference can be determined.

The following list is the possible use cases that can be supported by the item storage and retrieval system 101:
(a) Automatically move items from a home (or certain rooms) to off-site storage (or basement or attic);
(b) Use drones to do retrieval an item stored off-site storage in a timely manner;
(c) Move items nightly while people are sleeping, or at other convenient times;
(d) Use Drone or robot to automatically move items out of home when a user decides not use the item the next day;
(e) Use Drone or robot to automatically move items into home when a user decides to use the next day;
(f) Move general items (clothing, devices, etc.) to and from storage location(s) to specific places in a home;
(g) Request robot to store away personal belongings after work in office;
(h) Request robot to automatically move needed belongings to the work space booked in scheduling system before the employee reaches the office;
(i) Link to calendar used not just for events, but for categorized “life planning”
(j) Infer items needed at a time and place and move them accordingly;
(k) Learn and refine needs (both when and where, and by whom);
(l) Create and learn dependencies (if x, then needy) i.e. the system can be trained;
(m) Exchange or replace sets of furniture and decorations overnight, to change a room into a different room;
(n) Change furniture, decorations, etc. on a schedule, based themes, for aesthetic or artistic reasons (Not just at home, it applies to office or other places);
(o) Automatically borrow items from an online store or other warehouse, when the items are not already available or owned by the user or user's community, just with the addition of a small rental fee dependent on factors such as length of rental.

The methods described above may be implemented through the use of data processing systems. Often, the data processing system will include a memory for storing software (e.g. computer program or machine readable computer program code) instructions. Embodiments of the invention may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device (addressable through a network). In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the microprocessor of a data processing system.

A machine readable media can be used to store software and data which when executed by a data processing system causes the system to perform various methods of the present invention. This executable software and data may be stored in various places including for example ROM, volatile RAM, non-volatile memory and/or cache. Portions of this software and/or data may be stored in any one of these storage devices.

Thus, a machine readable media includes any mechanism that provides (i.e., stores and/or transmits) information in a form accessible by a machine (e.g. a computer, network device, personal digital assistant, manufacturing tool, any device with a set of one or more processors, etc.). For example, a machine readable media includes recordable and/or non-recordable media (e.g. read only memory (ROM); random access memory (RAM); magnetic disk storage media; optical storage media; flash memory devices; etc.) as well as electrical, optical, acoustical or other forms of propagated signals (e.g. carrier waves, infrared signals, digital signals, etc.); etc.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed:

1. A method of moving an item from a first location to a second location, the method comprising:
characterizing the item with a set of item attributes:
characterizing the first location with a set of first location attributes;
characterizing the second location with a set of second location attributes;
specifying goals for the item to move from the first location to a second location;
accessing an origin template stored in a data store wherein the origin template is associated with the item and the first location;
accessing a destination template stored in the data store wherein the destination template is associated with the item and the second location;
generating a moving plan from the origin template, the destination template and the goals; and
executing the moving plan with an agent that moves the item from the first location to the second location.

2. The method of claim 1 wherein characterizing the item with a set of item attributes comprises:
identifying the item;
tagging the item with an item RFID device;
determining geographic coordinates of the item; and
specifying a set of item characteristics associated with the item.

3. The method of claim 1 wherein characterizing the first location with a set of first location attributes comprises:
identifying the first location
measuring the first location;
tagging the first location with a first location RFID device;
determining geographic coordinates of the first location; and
specifying a set of first location characteristics.

4. The method of claim 1 further comprising:
determining a pattern applicable to movement of the item from the first location to the second location.

5. The method of claim 1 further comprising:
selecting exception handling options for the moving plan.

6. The method of claim 1 wherein executing the moving plan comprises:
executing the moving plan based on a schedule that is adjusted automatically based on a calendar.

7. The method of claim 1 wherein the agent comprises a robot.

8. A system for moving an item from a first location to a second location, the system comprising:
a processor;
a storage medium coupled to the processor;
a location characterization subsystem, coupled to the processor, that determines attributes of the first location and attributes of the second location and stores the attributes of the first location and the attributes of the second location in the storage medium
an item characterization subsystem, coupled to the processor, that determines the attributes of the item and stores the attributes of the item in the storage medium;
an item storage and retrieval management module, coupled to the processor, that executes instructions for
specifying goals for the item to move from the first location to a second location;
accessing an origin template stored in a data store wherein the origin template is associated with the item and the first location;
accessing a destination template stored in the data store wherein the destination template is associated with the item and the second location;
generating a moving plan from the origin template, the destination template and the goals; and
executing the moving plan with an agent that moves the item from the first location to the second location;
a moving agent; and
a user interface.

9. The system of claim 8 wherein the location characterization subsystem comprises a subsystem that:
identifies the first location in the second location;
measures the first location on the second location;
tags the first location with a first RFID device;
tags the second location with a second RFID device;
determines geographic coordinates of the first location and the second location; and
specifies a set of first location characteristics associated with the first location and a set of second location characteristics associated with a second location.

10. The system of claim 8 wherein the item characterization subsystem comprises a subsystem that:
identifies the item;
models the item;
tags the item with a first RFID device;
determines a location of the item; and
specifies a set of item characteristics associated with the item.

11. The system of claim 8 wherein the item storage and retrieval management module comprises:
an item modeling, classification and tracking component;
a design module;
a plan and calendar module;
and plan execution module.

12. The system of claim 11 wherein the item modeling, classification and tracking component comprises:
an item modeling, classification and tracking component that generates metadata associated with the item
a location modeling and classification component that generates metadata associated with the first location in the second location; and
an item and location tracking and change direction component that generates metadata associated with a change in location of the item.

13. The system of claim 11 wherein the design module comprises:
a goal specification and plan derivation component that accesses stored templates associated with the item, the first location, and the second location.

14. The system of claim 11 wherein the plan and calendar module comprises
a calendar module;
a dependence analytics and management module;
an exception handling preplanning module;
a preplanned execution sequence and command generation component; and
a resource looking module.

15. The system of claim 11 wherein the plan execution module comprises:
a preplanned task information validation component;
a real time adjustment component;
a real time dispatch and control component;
a client communication and notification component;
a real time logging component; and
a monitoring and auditing component.

16. A storage medium including machine readable computer program code including instructions for causing a processor to implement a method comprising:
identifying an item to be moved wherein the item has been characterized with a set of item attributes;
identifying a first location wherein the first location has been characterized with a set of first location attributes;
identifying a second location, wherein the second location has been characterized with a set of second location attributes;
specifying moving goals by
accessing an origin template stored in a data store wherein the origin template is associated with the set of item attributes and the set of first location attributes;
accessing a destination template stored in the data store wherein the destination template is associated with the set of item attributes and the set of second location attributes;
developing a moving plan from the origin template and the destination template; and
executing the moving plan with an agent that moves the item from the first location to the second location.

17. The storage medium of claim 16 wherein the set of item attributes comprises:
an item RFID identification;
item dimensions; and
item geolocation data of the item.

18. The storage medium of claim 17 wherein the set of first location attributes comprises;
first location dimensions;
a first location RFID identification;
first location geolocation data of the first location.

19. The storage medium of claim 18 further comprising building associations and relationship among the item and between the item and the first location geolocation data and the item geolocation data.

20. The storage medium of claim 16 further comprising providing exception handling options for the moving plans.
